(19) United States
(12) Patent Application Publication
(10) Pub. No.: US 2012/0201494 A1
(43) Pub. Date: Aug. 9, 2012

(54) OPTICAL SWITCH

(75) Inventor: Kanako SUZUKI, Hitachi (JP)

(73) Assignee: HITACHI CABLE, LTD., Tokyo (JP)

(21) Appl. No.: 13/356,873

(22) Filed: Jan. 24, 2012

(30) Foreign Application Priority Data
Feb. 9, 2011 (JP) 2011-026309

(51) Int. Cl. G02B 6/35

(52) U.S. Cl. 385/16

(57) ABSTRACT

An optical switch includes a first connector holding an end of at least one optical fiber and a second connector holding respective ends of at least two optical fibers. The optical switch further includes a sliding mechanism faces a connecting surface of the first connector and a connecting surface of the second connector each other, to optically connect between the at least one optical fiber held in the first connector and one of the at least two optical fibers held in the second connector, and slides the connecting surface of the first connector and the connecting surface of the second connector relative to each other with keeping a facing state, and a spacer mechanism for preventing the respective end faces of the facing optical fibers held in the first and second connectors from contacting each other, or from contacting the connecting surfaces of the first and second connectors, respectively.

The present application is based on Japanese patent application No. 2011-026309 filed on Feb. 9, 2011, the entire contents of which are incorporated herein by reference.

### BACKGROUND OF THE INVENTION

1. Field of the Invention

This invention relates to an optical switch for optical transmission line switching. In particular, it relates to an optical switch which switches an optical transmission line by sliding together respective connecting surfaces of facing connectors which have respective exposed end faces of optical fibers.

2. Description of the Related Art

Some optical switches for optical transmission line switching have been configured to switch an optical transmission line by sliding together respective connecting surfaces of facing connectors which have respective exposed end faces of optical fibers. This sliding mechanism for the optical transmission line switching has used e.g. a solenoid, which has been miniaturized in recent years.

In the optical switches having the aforementioned configuration, the respective end faces of the facing optical fibers are contacted and rubbed against each other or against the connecting surfaces of the opposite connectors, respectively, during switching. Therefore, abutting-connection of the respective ends of the optical fibers will cause damage to the end faces thereof

Accordingly, it is required to provide a measure for preventing the damage to the respective end faces of the facing optical fibers due to the repetition of switching.

Conventional optical switches are disclosed by Japanese Patent Laid-Open No. 2-166412 (JP-A-2-166412) and Japanese Patent Laid-Open No. 4-257820 (JP-A-4-257820).

### SUMMARY OF THE INVENTION

As a conventional method for preventing the damage to the respective end faces of the facing optical fibers, a method of providing a micro spacing (on the order of several micrometers to several tens of micrometers) between the respective connecting surfaces of the facing connectors to propagate optical signals in the spacing therebetween has been proposed. However, when the optical signals are spatially propagated in the spacing between the respective connecting surfaces of the facing connectors, there is the problem in that multiple reflections occurs between the connecting surfaces in the case of using the spacing of the order of several micrometers. On the other hand, there is another problem in that the insertion loss is significant in the case of using the spacing of the order of several tens of micrometers.

As a conventional method for avoiding these problems is to fill the spacing between the respective connecting surfaces of the facing connectors with a refractive index matching material. However, in this conventional method, there is a problem with long-term reliability, since the refractive index matching material is likely to be dry, or air bubbles are likely to be produced in the refractive index matching material by the sliding during switching.

Further, this method requires precision control of the spacing in order to suppress product to product variations. However, the control of the spacing is not easy, since the spacing is as micro as on the order of several micrometers to several tens of micrometers.

Accordingly, it is an object of the present invention to provide an optical switch, which can prevent damage to respective end faces of facing optical fibers due to the repetition of switching, prevent multiple reflections between respective connecting surfaces of facing connectors, and suppress an increase in insertion loss, and which is easy to be produced.

According to a feature of the invention, an optical switch comprises:

a first connector including a connecting surface and holding an end of at least one optical fiber, an end face of the at least one optical fiber being exposed at the connecting surface of the first connector;

a second connector including a connecting surface and holding respective ends of at least two optical fibers, respective end faces of the at least two optical fibers being exposed at the connecting surface of the second connector;

a sliding mechanism for facing the connecting surface of the first connector and the connecting surface of the second connector each other, to optically connect between the at least one optical fiber held in the first connector and one of the at least two optical fibers held in the second connector, and for sliding the connecting surface of the first connector and the connecting surface of the second connector relative to each other with keeping a facing state, to optically connect between the at least one optical fiber held in the first connector and an other of the at least two optical fibers held in the second connector; and

a spacer mechanism for preventing the respective end faces of the facing optical fibers held in the first connector and the second connector from contacting each other, or from contacting the connecting surface of the second connector and the connecting surface of the first connector, respectively.

The spacer mechanism may comprise a sheet member interposed between the connecting surface of the first connector and the connecting surface of the second connector,

in which the sheet member is formed with a through hole in a portion thereof where the respective end faces of the facing optical fibers are exposed.

The sheet member may be formed to have such a thickness that a spacing between the respective end faces of the facing optical fibers held in the first connector and the second connector is not less than 5 μm and not more than 15 μm.

The spacer mechanism may comprise the connecting surface of the first connector and the connecting surface of the second connector, which are tilted at different angles, respectively.

The connecting surface of the first connector and the connecting surface of the second connector may be tilted at such angles, respectively, that a spacing between the respective end faces of the facing optical fibers held in the first connector and the second connector is not more than 15 μm, excluding 0 μm.

The optical switch may further comprise:

a guide pin provided to one of the connecting surfaces of the first and second connectors; and

a guide hole formed in an other of the connecting surfaces of the first and second connectors,

in which the guide pin is inserted in the guide hole, and when the connecting surfaces of the first and second connectors are slid together, a sliding direction and a sliding distance are restricted.

(Points of the Invention)

According to the embodiment of the invention, the spacer mechanism is included, so that the respective end faces of the facing optical fibers held in the first connector and the second connector are prevented from contacting each other, or from contacting the connecting surface of the second connector and the connecting surface of the first connector, respectively. This spacer mechanism can prevent the damage to the respective end faces of the facing optical fibers even due to the repetition of switching.

### BRIEF DESCRIPTION OF THE DRAWINGS

The preferred embodiments according to the invention will be explained below referring to the drawings, wherein:

FIG. 1 is a perspective view showing an optical switch according to the invention;

FIG. 2 is an explanatory diagram showing switching of the optical switch;

FIG. 3A is a diagram showing one example of a configuration of a connecting surface of a first connector;

FIG. 3B is a diagram showing one example of a configuration of a connecting surface of a second connector;

FIG. 4A is a diagram showing one example of a configuration of a connecting surface of a first connector;

FIG. 4B is a diagram showing one example of a configuration of a connecting surface of a second connector;

FIG. 5 is a diagram showing one example of a sliding mechanism;

FIG. 6 is a diagram showing one example of the sliding mechanism;

FIG. 7 is a diagram showing one example of the sliding mechanism;

FIG. 8 is a diagram showing one example of the sliding mechanism;

FIG. 9 is a diagram showing one example of the sliding mechanism;

FIG. 10 is a diagram showing one example of the sliding mechanism;

FIG. 11 is a diagram showing one example of the sliding mechanism;

FIG. 12 is a diagram showing one example of the sliding mechanism;

FIG. 13 is a diagram showing an example of a product using the optical switch;

FIG. 14 is a diagram showing a configuration of a spacer mechanism;

FIG. 15 is a cross sectional view showing the optical switch when provided with the spacer mechanism;

FIG. 16 is an explanatory diagram showing operation of the spacer mechanism;

FIGS. 17A and 17B are diagrams showing a variation of the spacer mechanism;

FIG. 18 is a diagram showing the relationship between the tilt angle of the connecting surface and the size of the spacing;

FIG. 19 is a diagram showing the relationship between the size of the spacing and the insertion loss; and

FIG. 20 is an explanatory diagram showing operation of the spacer mechanism.

### DETAILED DESCRIPTION OF THE PREFERRED EMBODIMENTS

Below is described a preferred embodiment according to the invention, in conjunction with the accompanying drawings.

(Optical Switch 10)

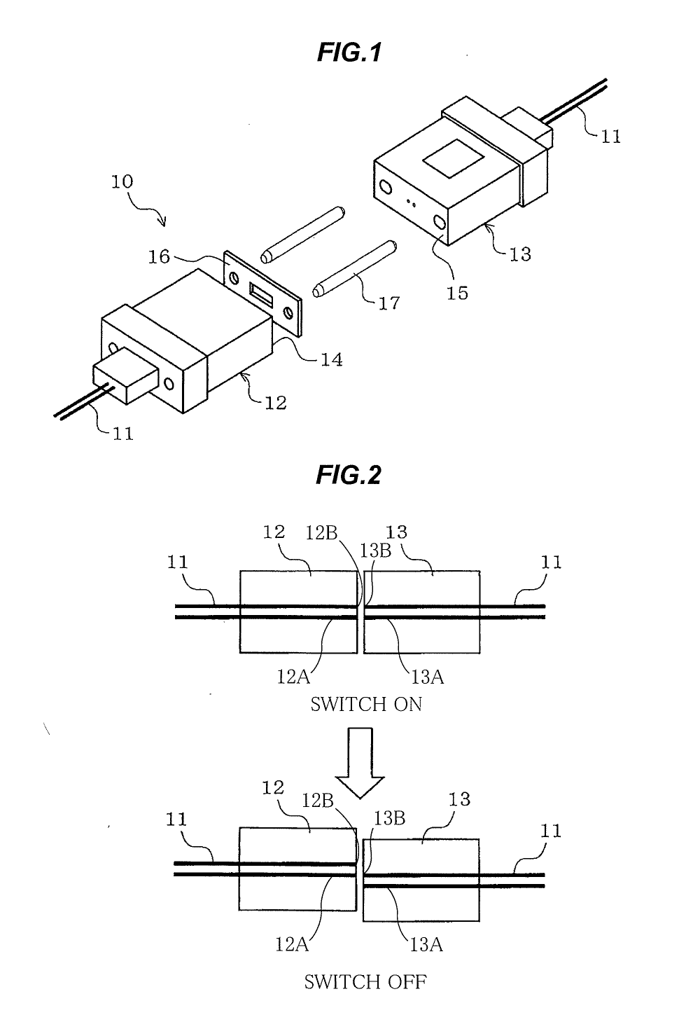

FIGS. 1 and 2 show a perspective view showing an optical switch 10 in the preferred embodiment according to the invention.

As shown in FIGS. 1 and 2, the optical switch 10 in this embodiment includes a first connector 12 for holding an end 12A of at least one optical fiber (in FIG. 1, two optical fibers) 11 and an exposed end face 12B of the at least one optical fiber 11, a second connector 13 for holding respective ends 13A of at least two optical fibers (in FIG. 1, two optical fibers) 11 and respective exposed end faces 13B of the at least two optical fibers 11, and a sliding mechanism (not shown) whereby respective connecting surfaces 14 and 15 of the first connector 12 and the second connector 13 with the respective exposed end faces 12B, 13B of the optical fibers 11 at the connecting surfaces 14 and 15 face each other with no intervening refractive index matching material therebetween, to optically connect together the optical fiber 11 held in the first connector 12 and one of the optical fibers 11 held in the second connector 13, so that the respective connecting surfaces 14 and 15 of the first connector 12 and the second connector 13 face each other and slide relative to each other, to optically connect together the optical fiber 11 held in the first connector 12 and an other of the optical fibers 11 held in the second connector 13.

The optical fibers 11 may use e.g. a 125 μm diameter single mode optical fiber, or multimode optical fiber.

(First Connector 12 and Second Connector 13)

One of the first connector 12 and the second connector 13 is fixed, while the other thereof is movable by the sliding mechanism. Herein, the first connector 12 acts as the fixed connector, while the second connector 13 acts as the movable connector. Referring to FIG. 2, the optical switch 10 performs switching as follows: The optical transmission line is switched by sliding the second connector 13 with the sliding mechanism.

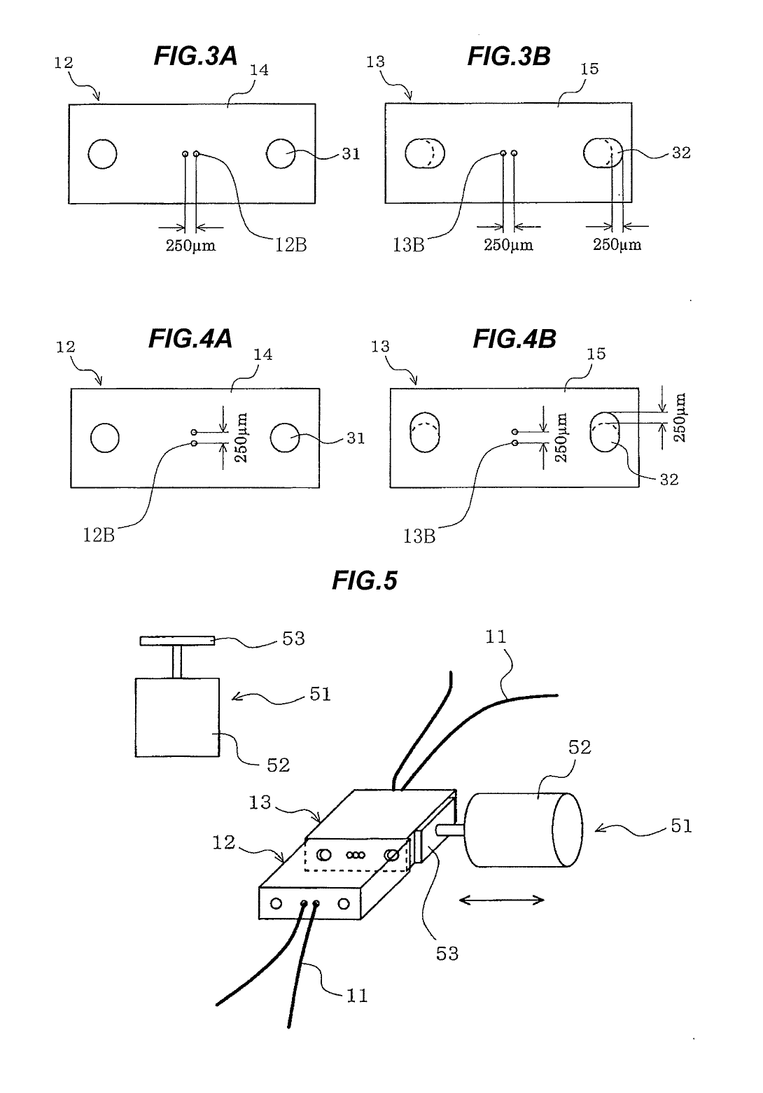

The first connector 12 and the second connector 13 are each configured as an existing MT (Mechanical Transfer) connector. Referring to FIGS. 3A and 3B, the respective connecting surfaces 14 and 15 of the first connector 12 and the second connector 13 have the respective exposed end faces 12B, 13B of the optical fibers 11 held in the first connector 12 and the second connector 13.

In this embodiment, the 125 μm diameter optical fibers 11 are used, and are aligned and held at a pitch of 250 μm so that there can be the space equivalent to one optical fiber between the respective end faces 12B, 12B (or 13B, 13B) of the adjacent optical fibers 11.

Also, the connecting surface 14 of the first connector 12 is formed with two guide pin insertion holes 31 for being provided with two guide pins 17 respectively (see FIG. 1). On the other hand, the connecting surface 15 of the second connector 13 is formed with two guide holes 32 in which the two guide pins 17 are inserted respectively.

In comparison with the diameter of the guide pin insertion holes 31, the diameter of the guide holes 32 is formed to be large in the sliding direction of the second connector 13 by the amount of the pitch at which the optical fibers 11 are aligned and held. This enables the movement of the guide pins 17 to be regulated within the guide holes 32, thereby allowing the regulation of the sliding direction and the sliding distance in sliding together the respective connecting surfaces 14 and 15 of the first connector 12 and the second connector 13.

In this embodiment, the guide holes 32 are configured so that the respective connecting surfaces 14 and 15 of the first connector 12 and the second connector 13 slide together in the horizontal direction shown in FIGS. 3A and 3B. However, the guide holes 32 may be such configured that the respective connecting surfaces 14 and 15 of the first connector 12 and the second connector 13 slide together in the vertical direction shown in FIGS. 4A and 4B.

(Sliding Mechanism 51)

Referring to FIGS. 5 to 12, the sliding mechanism 51 is configured primarily as a solenoid (or electromagnet) 52. The solenoid 52 is provided with a pressing member 53 for pressing and holding the second connector 13. This sliding mechanism 51 performs the optical transmission line switching by switching ON and OFF the power of the solenoid 52.

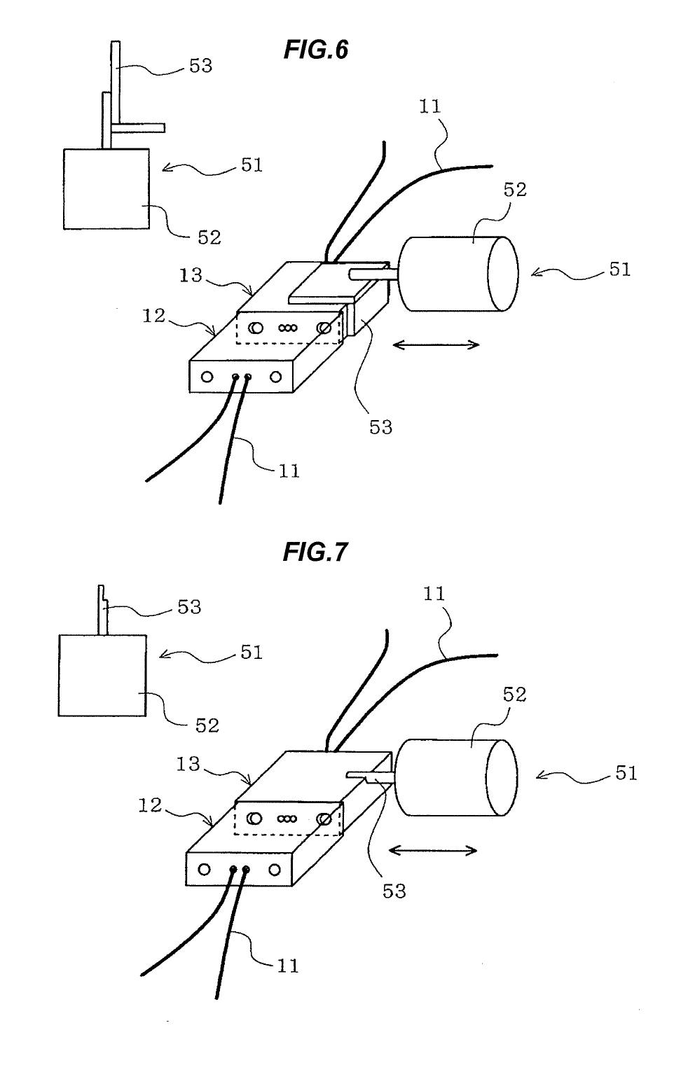

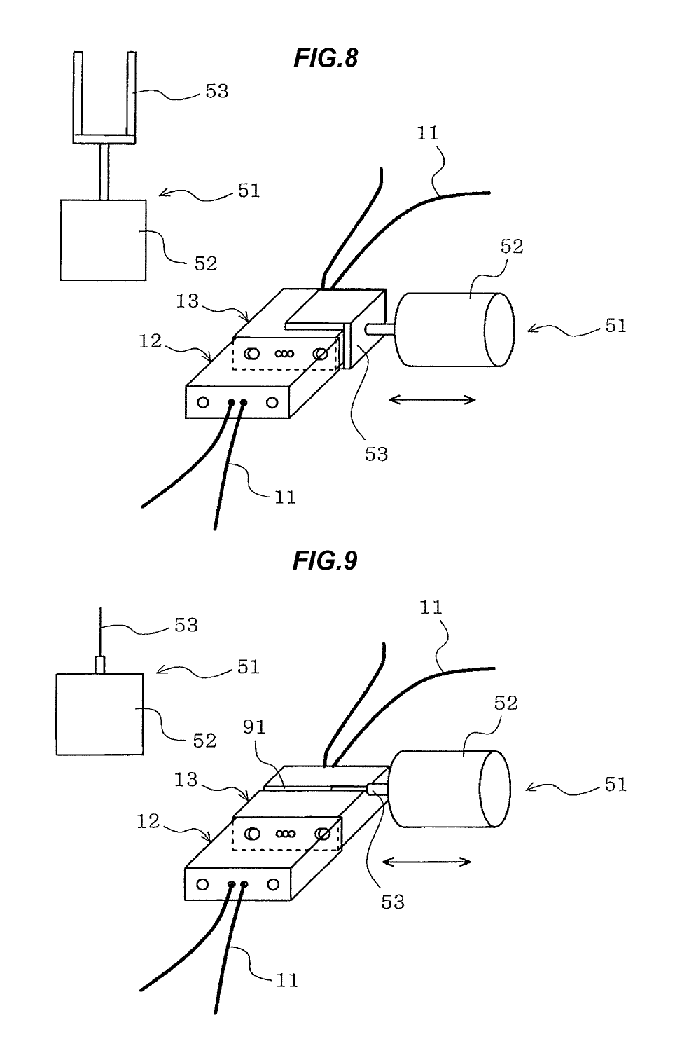

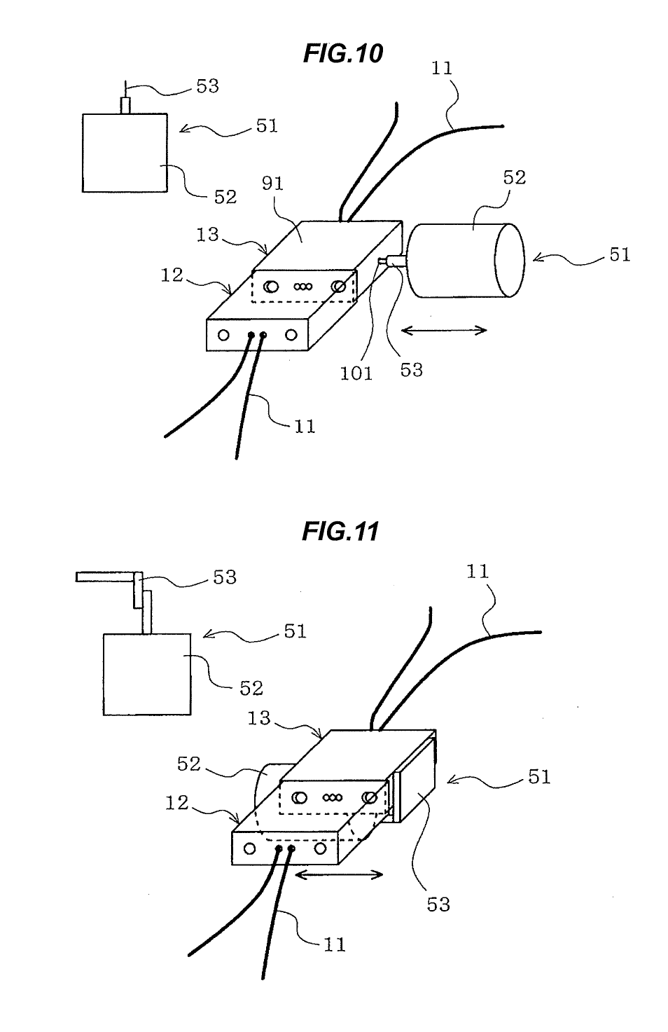

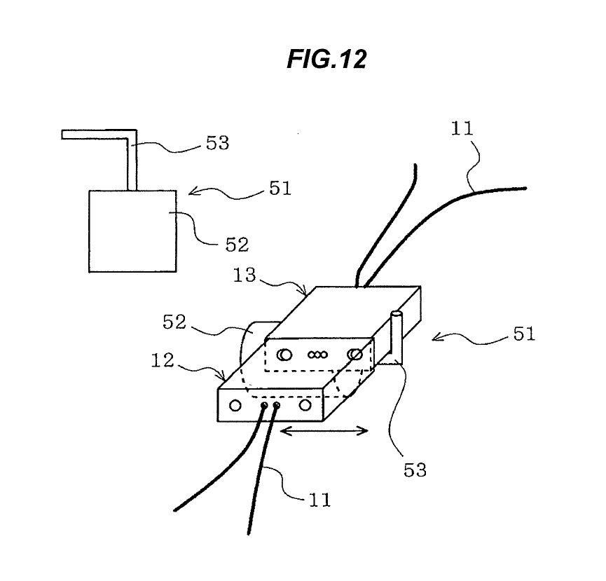

As the specific structure of the pressing member 53, there can be considered a T-shape surface pressing structure as shown in FIG. 5, an L-shape surface pressing structure as shown in FIG. 6, an L-shape pin pressing structure as shown in FIG. 7, a U-shape surface pressing structure as shown in FIG. 8, a V-groove pressing structure as shown in FIG. 9, a mating tip pressing structure as shown in FIG. 10, a small size L-shape surface pressing structure as shown in FIG. 11, a small size L-shape pin pressing structure as shown in FIG. 12, and the like.

In the T-shape surface pressing structure of FIG. 5, the pressing member 53 is configured as a T-shape surface, so that the optical transmission line switching is performed by pushing and pulling a side surface of the second connector 13 with the T-shape surface of the pressing member 53. According to this structure, the second connector 13 can be pushed without misalignment because the second connector 13 is pressed by the T-shape surface.

In the L-shape surface pressing structure of FIG. 6, the pressing member 53 is configured as an L-shape surface, so that the optical transmission line switching is performed by pushing and pulling an upper surface and a side surface of the second connector 13 with the L-shape surface of the pressing member 53. According to this structure, the second connector 13 can be pushed without misalignment because the second connector 13 is pressed by the L-shape surface. Also, this structure is more stable in comparison to the T-shape surface pressing structure of FIG. 5, because it presses the upper surface of the second connector 13, as well as the side surface thereof.

In the L-shape pin pressing structure of FIG. 7, the pressing member 53 is configured as an L-shape pin provided at a tip of the solenoid 52, so that the optical transmission line switching is performed by pushing and pulling the second connector 13 with the L-shape pin of the pressing member 53. According to this structure, the weight reduction is ensured in comparison to the above described surface pressing structures of FIGS. 5 and 6.

In the U-shape surface pressing structure of FIG. 8, the pressing member 53 is configured as a U-shape surface, so that the optical transmission line switching is performed by pushing and pulling an upper surface, a side surface and a lower surface of the second connector 13 with the U-shape surface of the pressing member 53. According to this structure, the second connector 13 can be pushed without misalignment because the second connector 13 is pressed by the U-shape surface. Also, this structure is more stable in comparison to the T-shape surface pressing structure of FIG. 5, or the L-shape surface pressing structure of FIG. 6, because it presses the upper surface and the lower surface of the second connector 13, as well as the side surface thereof.

In the V-groove pressing structure of FIG. 9, the pressing member 53 is configured as a pin provided at a tip of the solenoid 52, and an upper surface of the second connector 13 is formed with a solenoid fixing V groove 91, and the pressing member 53 is fixed to the solenoid fixing V groove 91 with an adhesive, so that the optical transmission line switching is performed by pushing and pulling the second connector 13 with the pressing member 53. According to this structure, the weight reduction is ensured in comparison to the above described surface pressing structures of FIGS. 5, 6 and 8.

In the mating tip pressing structure of FIG. 10, the pressing member 53 is configured as a pin provided at a tip of the solenoid 52, and a side surface of the second connector 13 is formed with a mating hole 101 for mating the pressing member 53, and the pressing member 53 is mated and fixed to the mating hole 101, so that the optical transmission line switching is performed by pushing and pulling the second connector 13 with the pressing member 53. This structure can ensure weight reduction in comparison to the above described surface pressing structures of FIGS. 5, 6 and 8.

In the small size L-shape surface pressing structure of FIG. 11, the solenoid 52 is disposed on a lower surface of the second connector 13, and the pressing member 53 is configured as an L-shape surface, so that the optical transmission line switching is performed by pushing and pulling the lower surface and a side surface of the second connector 13 with the L-shape surface of the pressing member 53. According to this structure, the second connector 13 can be pushed without misalignment because the second connector 13 is pressed by the L-shape surface. Also, according to this structure, the size reduction of the entire optical switch 10 is ensured, because the solenoid 52 is disposed on the lower surface of the second connector 13.

In the small size L-shape pin pressing structure of FIG. 12, the solenoid 52 is disposed on a lower surface of the second connector 13, and the pressing member 53 is configured as an L-shape pin provided at a tip of the solenoid 52, so that the optical transmission line switching is performed by pushing and pulling the second connector 13 with the L-shape pin of the pressing member 53. According to this structure, the size reduction of the entire optical switch 10 is ensured, because the solenoid 52 is disposed on the lower surface of the second connector 13.

(Example of a Product Using the Optical Switch 10)

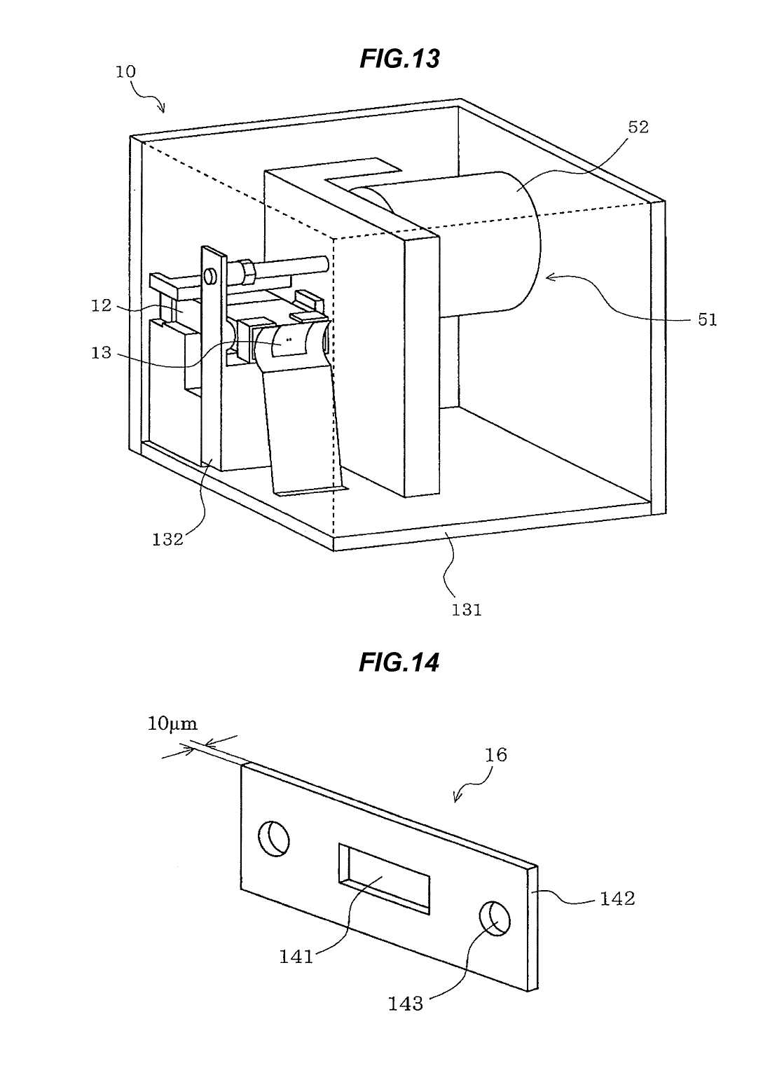

FIG. 13 shows an example of a product using the above described optical switch 10.

As shown in FIG. 13, for example, the first connector 12, the second connector 13 and the sliding mechanism 51 are received within a chassis 131, to provide the optical switch 10 as a commercial product. In this product example, the sliding mechanism 51 is configured as a sliding jig 132 for supporting the solenoid 52 and the second connector 13.

(Spacer Mechanism 16)

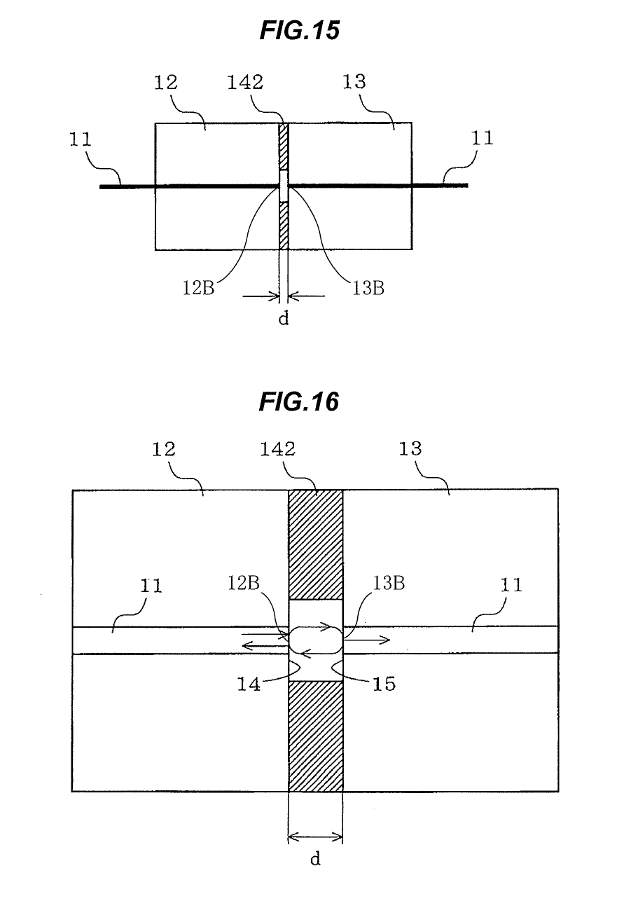

The optical switch 10 according to the invention is characterized by including a spacer mechanism 16 as shown in FIGS. 1, 14 and 15 for preventing the respective end faces 12B, 13B of the facing optical fibers 11 held in the first connector 12 and the second connector 13 from contacting each other, or from contacting the connecting surface 15 of the second connector 13 and the connecting surface 14 of the first connector 12 on the opposite side, respectively.

The spacer mechanism 16 comprises a sheet member 142 interposed between the respective connecting surfaces 14 and 15 of the first connector 12 and the second connector 13, and formed with a through hole 141 in a portion thereof where the respective end faces 12B, 13B of the facing optical fibers 11 are exposed. The sheet member 142 may use a stainless steel material with good workability, or the like.

The sheet member 142 is formed with two guide pin insertion holes 143 through which the two guide pins 17 respectively are inserted. Inserting the two guide pins 17 through the two guide pin insertion holes 143 respectively results in the sheet member 142 being positioned and fixed to between the first connector 12 and the second connector 13.

The sheet member 142 be preferably formed to have such a thickness that the spacing d between the respective end faces 12B, 13B of the facing optical fibers 11 held in the first connector 12 and the second connector 13 is not less than 5 μm and not more than 15 μm. If the spacing d is less than 5 μm, there will be the problem that multiple reflections as shown in FIG. 16 occur between the respective connecting surfaces 14 and 15 of the first connector 12 and the second connector 13. Further, so as to set the spacing d at less than 5 μm, the sheet member 142 should be formed to have a thickness of less than 5 μm. However, the sheet member 142 having such a thickness cannot be produced with good accuracy at the current working accuracy. On the other hand, if the spacing d exceeds 15 μm, the insertion loss will be significantly increased.

(Advantages of the Optical Switch 10)

In the optical switch 10 having the aforementioned configuration, the sheet member 142 is interposed between the respective connecting surfaces 14 and 15 of the first connector 12 and the second connector 13, thereby preventing the damage to the respective end faces 12B, 13B of the facing optical fibers 11 even though the switching is repeated.

Further, the optical switch 10 can be provided with the micro spacing d between the respective connecting surfaces 14 and 15 of the first connector 12 and the second connector 13, by the simple method interposing the sheet member 142 therebetween. Therefore, the production of the optical switch 10 is low cost and simple.

Still further, the optical switch 10 uses no refractive index matching material. Therefore, the long-term reliability thereof is excellent.

(Variation of the Spacer Mechanism 16)

Next, a variation of the spacer mechanism 16 will be described below.

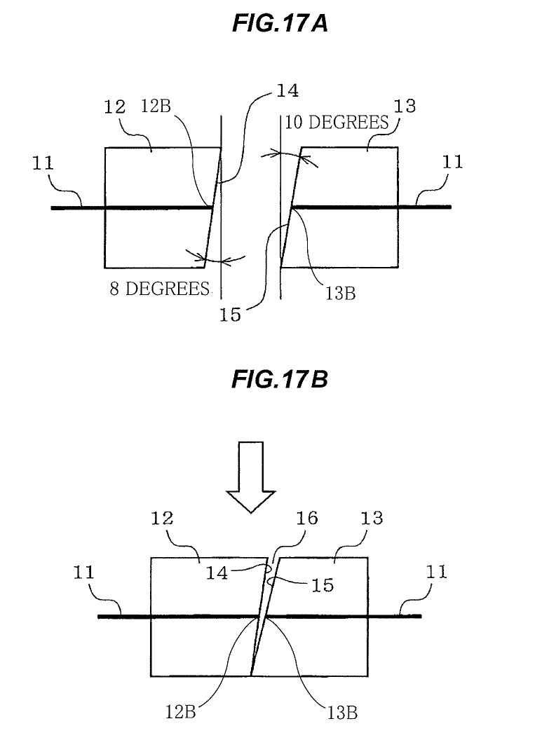

Referring to FIGS. 17A and 17B, the variation of the spacer mechanism 16 comprises the respective connecting surfaces 14 and 15 of the first connector 12 and the second connector 13, which are sloped (tilted) at different angles (e.g. 8 degrees and 10 degrees), respectively. In the first connector 12, the end faces 12B of the optical fiber 11 and the connecting surface 14 are formed to be coplanar, while in the second connector 13, the end faces 13B of the optical fiber 11 and the connecting surface 15 are formed to be coplanar.

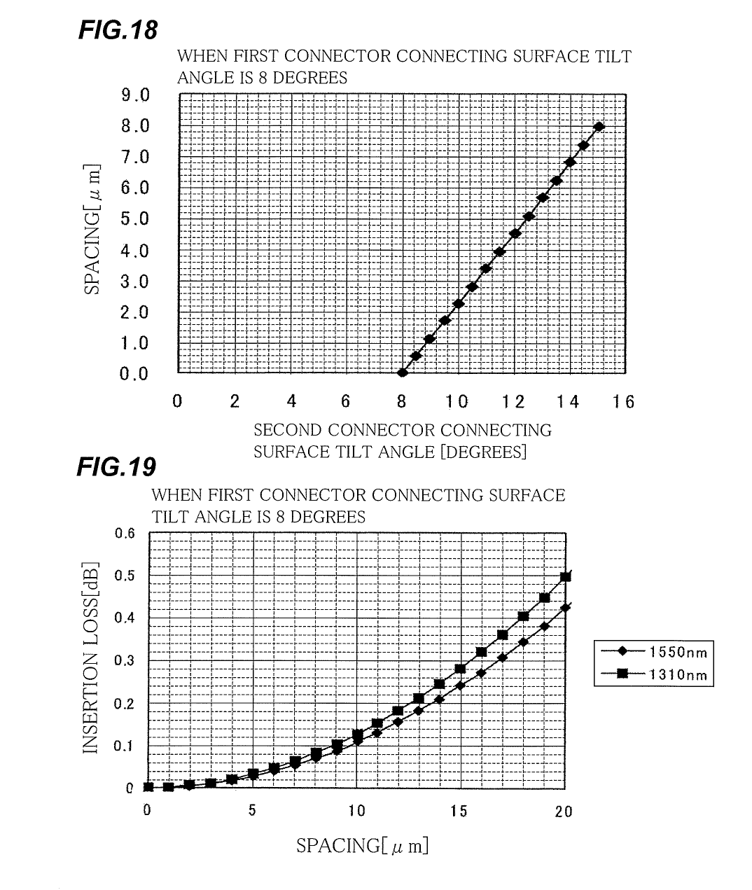

FIG. 18 shows the relationship between the tilt angle of the connecting surface 15 of the second connector 13 and the spacing d, when the tilt angle of the connecting surface 15 of the second connector 13 is varied with the connecting surface 14 of the first connector 12 remaining fixed at the tilt angle of 8 degrees.

As shown in FIG. 18, the size of the spacing d between the respective end faces 12B, 13B of the facing optical fibers 11 can be changed by adjusting the tilt angle of the connecting surface 15 of the second connector 13. The connecting surfaces 14 and 15 can be tilted by a known APC (Angled Physical Contact) polishing technique.

FIG. 19 shows the relationship between the spacing d and the insertion loss, when the spacing d is varied with the connecting surface 14 of the first connector 12 remaining fixed at the tilt angle of 8 degrees. As seen from FIG. 19, when the spacing d is not more than 15 μm (excluding 0 μm), the insertion loss can be as small as less than on the order of 0.3 dB, and further when the spacing d is not more than 10 μm (excluding 0 μm), the insertion loss can be as very small as less than on the order of 0.15 dB.

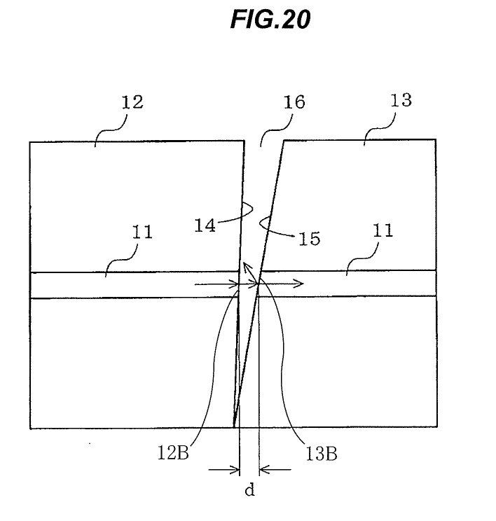

In this manner, the spacer mechanism 16 is modified so that the connecting surfaces 14 and 15 of the first connector 12 and the second connector 13 are formed at the different tilt angles respectively. According to this structure, an optical signal is reflected toward an opening of the spacing d as shown in FIG. 20 (i.e. upward in FIG. 20), even when the spacing d between the respective end faces 12B, 13B of the facing optical fibers 11 is not more than 5 μm. Therefore, no problem of multiple reflections arises.

That is, in comparison to the spacer mechanism 16 comprising the sheet member 142 interposed between the respective connecting surfaces 14 and 15 of the first connector 12 and the second connector 13, the modified spacer mechanism 16 comprises the respective sloped connecting surfaces 14 and 15 of the first connector 12 and the second connector 13 which have the different tilt angles respectively, therefore allowing the optical signal to be reflected toward the opening of the spacing d (i.e. upward in FIG. 20). The modified spacer mechanism 16 has no problem of multiple reflections, and can make the spacing d smaller, and reduce the insertion loss.

Since the known APC polishing technique can be used for tilting the connecting surfaces 14 and 15, the spacing d can be controlled with good accuracy, and the production of the optical switch 10 is therefore low cost, and simple. Also, since no refractive index matching material is used, the long-term reliability of the optical switch 10 is excellent.

It is preferable to use both the spacer mechanism 16 of FIG. 14 and the modified spacer mechanism 16 of FIGS. 17A and 17B according to use applications. When the insertion loss is allowed to be somewhat great, the spacer mechanism 16 may be configured as the sheet member 142, and when the insertion loss is required to be reduced, the spacer mechanism 16 may be configured so that the respective connecting surfaces 14 and 15 of the first connector 12 and the second connector 13 are tilted.

Further, in the modified spacer mechanism 16 of FIGS. 17A and 17B, one of the respective connecting surfaces 14 and 15 of the first connector 12 and the second connector 13 is provided with the guide pins 17, while the other of the respective connecting surfaces 14 and 15 of the first connector 12 and the second connector 13 is formed with the guide holes 32 in which the guide pins 17 respectively are inserted. For that, even when the first connector 12 and the second connector 13 are connected together as pressed against each other by using a spring and the like, there can be formed the spacing d between the respective end faces 12B, 13B of the facing optical fibers 11, and there can also be maintained the size of the spacing d (i.e. the respective entire connecting surfaces 14 and 15 of the first connector 12 and the second connector 13 are not contacted and connected together). Therefore, the respective end faces 12B, 13B of the facing optical fibers 11 cannot be damaged, and also the insertion loss can be held constant, even when the switching of the optical switch 10 is repeated.

Although the invention has been described, the invention according to claims is not to be limited by the above-mentioned embodiments and examples. Further, please note that not all combinations of the features described in the embodiments and the examples are not necessary to solve the problem of the invention.

What is claimed is:

1. An optical switch, comprising:
a first connector including a connecting surface and holding an end of at least one optical fiber, an end face of the at least one optical fiber being exposed at the connecting surface of the first connector;
a second connector including a connecting surface and holding respective ends of at least two optical fibers, respective end faces of the at least two optical fibers being exposed at the connecting surface of the second connector;
a sliding mechanism for facing the connecting surface of the first connector and the connecting surface of the second connector each other, to optically connect between the at least one optical fiber held in the first connector and one of the at least two optical fibers held in the second connector, and for sliding the connecting surface of the first connector and the connecting surface of the second connector relative to each other with keeping a facing state, to optically connect between the at least one optical fiber held in the first connector and an other of the at least two optical fibers held in the second connector; and
a spacer mechanism for preventing the respective end faces of the facing optical fibers held in the first connector and the second connector from contacting each other, or from contacting the connecting surface of the second connector and the connecting surface of the first connector, respectively.

2. The optical switch according to claim 1, wherein the spacer mechanism comprises a sheet member interposed between the connecting surface of the first connector and the connecting surface of the second connector,
wherein the sheet member is formed with a through hole in a portion thereof where the respective end faces of the facing optical fibers are exposed.

3. The optical switch according to claim 2, wherein the sheet member is formed to have such a thickness that a spacing between the respective end faces of the facing optical fibers held in the first connector and the second connector is not less than 5 μm and not more than 15 μm.

4. The optical switch according to claim 1, wherein the spacer mechanism comprises the connecting surface of the first connector and the connecting surface of the second connector, which are tilted at different angles, respectively.

5. The optical switch according to claim 4, wherein the connecting surface of the first connector and the connecting surface of the second connector are tilted at such angles, respectively, that a spacing between the respective end faces of the facing optical fibers held in the first connector and the second connector is not more than 15 μm, excluding 0 μm.

6. The optical switch according to claim 1, further comprising:
a guide pin provided to one of the connecting surfaces of the first and second connectors; and
a guide hole formed in an other of the connecting surfaces of the first and second connectors,
wherein the guide pin is inserted in the guide hole, and when the connecting surfaces of the first and second connectors are slid together, a sliding direction and a sliding distance are restricted.
